(19) United States
(12) Patent Application Publication
(10) Pub. No.: US 2015/0287340 A1
(43) Pub. Date: Oct. 8, 2015

(54) METHOD AND SYSTEM FOR EVALUATION OF GROUND COMBAT VEHICLE MANOEUVRING

(71) Applicant: BAE Systems Hägglunds Aktiebolag, Örnsköldsvik (SE)

(72) Inventors: Per-Åke Nordlander, Bjasta (SE); Bo Lundberg, Ornskoldsvik (SE); Mikael Nergård, Ornskoldsvik (SE)

(73) Assignee: BAE Systems Hägglunds Aktiebolag, Örnsköldsvik (SE)

(21) Appl. No.: 14/399,782

(22) PCT Filed: May 3, 2013
(86) PCT No.: PCT/SE2013/050495

§ 371 Date: Nov. 7, 2014

(30) Foreign Application Priority Data
May 25, 2012 (SE) 1250533-5

(51) Int. Cl. G09B 19/16

(52) U.S. Cl. CPC G09B 19/167

(57) ABSTRACT

The invention pertains to a method for evaluation of ground combat vehicle manoeuvring during a mission performed by the ground combat vehicle. The method comprises the steps of during the mission registering (S1) mission related information comprising at least image and audio information using a sensor device (3) of the ground combat vehicle, and after completion of mission to reproduce (S2) the mission related information using a playback device (9) if the ground combat vehicle.

### TECHNICAL FIELD

The present invention relates to a method and a system for evaluation of ground combat vehicle manoeuvring. In particular the present invention relates to a method and a system for evaluation of ground combat vehicle manoeuvring in order to train and develop operators of ground combat vehicles, such as drivers, gunners and vehicle commanders. The present invention also relates to a computer programme for such evaluation.

### BACKGROUND

Upon training of operators of combat vehicles follow-up and evaluation of combat-like exercises and actual combat situations of high importance. Reviewing audio recordings, video recordings and various sensor data that have been registered during a mission provides operators of combat vehicles the possibility to identify what went well and less well during the mission and thereby gain knowledge developing their individual and joint ability to manoeuvre the combat vehicle in an efficient manner.

Modern ground combat vehicles of today often comprise different systems for registering mission related information, such as audio recording systems, image recording systems, navigation systems etc. Today it is required to manually compile the mission related information registered by the various sensor system of the combat vehicle in order to get an overview over what happened during the mission. Following manual compilation of the information, the information is often presented for review in an education room for evaluation of how the ground combat vehicle was manoeuvred by the vehicle crew during the mission.

The manual compilation of information is often time consuming and laborious which leads to that evaluation often is not performed. If the evaluation still takes place the time consuming and laborious compilation of the information leads to that long time passes between the mission and the following evaluation. This time delay leads to less efficient learning and thus non-optimal training/development of operators of ground combat vehicles.

WO 2008/106943 describes a camera installation for a military vehicle. The camera installation comprises at least one camera registering video sequences of the surroundings that can be seen by the vehicle driver, whereby the video sequence is displayed in a monitor in front of a passenger seat of the vehicle.

Sensor system for registering sequence of events in and around vehicles is also used in other contexts.

US 2010/0182398 describe for example a system for video and audio recordings of events occurring in and around a vehicle, such as a police vehicle. The recorded material can be displayed in monitor coupled to the vehicle. The purpose of the gathering of information is that the image and audio sequences should be able to constitute evidence upon criminal activity.

### SUMMARY OF THE INVENTION

An object of the present invention is to provide a novel and advantageous method and system for evaluation of ground combat vehicle manoeuvring.

In particular it is an object of the present invention to provide such method and system that enables minimal time delay between when a mission has been performed by the ground combat vehicle and evaluation of the manoeuvring of the ground combat vehicle during the mission.

Yet another object of the present invention is to provide a method and a system that automates compilation of mission related information registered by several components of the ground combat vehicle during a mission performed by the combat vehicle.

According to an aspect of the invention a system is provided, for evaluation of ground combat manoeuvring during a performed mission, comprising a sensor device for registering of mission related information, and a digital storage medium for storage of the information registered by the sensor device. The system further comprises at least one playback device that is arranged to reproduce the mission related information after completion of mission.

The system is integrated in a ground combat vehicle, wherein the invention also provides a ground combat vehicle with a built in system comprising at least one sensor device for registering of mission related information, a digital storage medium for storage of the information registered by the sensor device, and a playback device arranged to reproduce the mission related information in the vehicle after completion of mission.

Thereby, the proposed system enables review and evaluation of the ground combat vehicle manoeuvring performed during the mission immediately after completion of mission which leads to more efficient training and development of the operators having manoeuvred the vehicle during the mission.

The sensor device comprises at least one and advantageously both of the following components:

1) Audio Recording Device

The audio recording device is advantageously arranged to register conversations between the crew members of the vehicle (intercom-conversations), conversations between a crew member and persons such as combat/exercise leading coordinators outside of the vehicle (radio conversations), and/or other sounds in or outside of the vehicle that can be of relevance for the mission and thereby for manoeuvring of the vehicle.

2) Image Recording Device

The image recording device comprises one or more electro-optical sensors. Advantageously the image recording device comprise at least one digital video camera, but can instead of video cameras, or in combination with one or more video cameras, comprise one or more still camera.

Advantageously the image recording device comprises electro-optical sensors arranged to registers images that displays what takes place both inside the vehicle and outside the vehicle. In an advantageous embodiment the image recording device comprises an electro-optical sensor arranged to register images of at least parts of the field of view that is seen by a vehicle gunner. For example an electro-optical of the image recording device can be arranged in such way that the image recording device registers images corresponding to the view that the gunner see when the gunner aims a weapon of the ground combat vehicle.

The playback device comprises an audio playback device and/or a video playback device for reproducing the sounds and/or images that have been registered by the above mentioned audio and video recording devices.

The system also comprises a processing unit, such as a computer processor, wherein the processing unit is coupled to the digital storage medium for accessing the information (henceforth referred to as sensor information) registered by the sensor device and to the playback device for reproduction of the registered and stored sensor information. The processing unit is preferably coupled to at least one display screen for reproduction of registered images and at least microphone for reproduction of registered audio.

The processing unit can further be coupled to a navigation module of the ground combat vehicle so as to together with sensor information enable reproducing positional information relating to the geographical position of the vehicle or its movements during the mission. Advantageously the processing unit is also coupled to a digital storage medium storing visual terrain information relating to the geographical area in which the mission has been performed, such as map images or aerial photography. Thereby, the processing unit can be arranged to display on a display screen the position and/or movement of the vehicle during the mission in relation to the stored terrain information, for example by means of indicating the position of the vehicle on a map image or an aerial photography.

The processing unit is further suitably coupled to a weapon state module of the ground combat vehicle that registers the state of one or more weapon systems of the ground combat vehicle. Hereby, the processing unit is arranged to store weapon state information indicating the state of a weapon system of the ground combat vehicle at different instances of time during the mission. In this way the processing unit is enabled to cater that sensor information is reproduced together with weapon state information in order for reproduction of how the vehicle crew handled the weapon system under the circumstances.

The processing unit is further suitably coupled to a vehicle state module of the ground combat module that monitors and registers the state also of non weapon related systems of the vehicle, such as current settings for throttle action, brake action and steering action etc. Hereby, the processing unit is arranged to store vehicle state information that indicates the state of various vehicle system at different instances of time during the mission. In this way the processing unit is enabled to cater that sensor information together with vehicle state information is reproduced in order for reproduction of how the vehicle crew drove the vehicle under the circumstances.

Advantageously the processing unit is further arranged to cause mission related information of different types to be reproduced in a synchronized manor, meaning that the processing unit is arranged to take into account at which instances of time different types of mission related information was registered and ensure that the playback device reproduces information in such way that different types of information that was registered simultaneously also is reproduces simultaneously. Hereby, the processing unit can for example ensure that what was said in the vehicle at a certain instance of time and what the vehicle driver, the vehicle gunner and/or the vehicle commander saw (or should have seen) at this instance of time in retrospect can be reproduced simultaneously. By this is meant that the processing unit also preferably is arranged to reproduce the sensor information together with the positional information, the weapon state information and/or the vehicle state information in a synchronized fashion, which in analogy with what is stated above means that the sensor information is synchronized with the positional information, the weapon state information and/or the vehicle state information so that the sensor information that have been registered at a given instance of time is reproduced together with the other information that has been registered at the same instance of time.

By mission related information is herein meant all information that is registered by the system during a mission that is of relevance for how the vehicle crew manoeuvres or should manoeuvre the ground combat vehicle during the mission. As described above the system is at least arranged to register and store mission related information in the form of audio and/or image information registered by the sensor device of the system.

Advantageously the system is further arranged to register and store mission related information in the form of positional information, weapon state information and vehicle state information.

In an advantageous embodiment the system further comprises a statistics module. The statistics module can be comprised of said processing unit or coupled thereto. The statistics module is arranged to calculate the time delay between different events at least partly based on the registered mission related information, and to provide information to the vehicle crew based on said time delay. As an example it can be mentioned that the statistics module can be arranged to register a time delay indicative of the time it takes from when the vehicle crew should be able to identify a hostile target until the vehicle crew has fired a shot to combat the target. As another example can be mentioned that the statistics module can be arranged to register the time delay from when a vehicle commander give verbal order of firing until a vehicle gunner fires a shot. As yet another example it can be mentioned that the statistics module can be arranged to register the time delay from when the ground combat vehicles assumes first geographical position until that it has moved to assume a second geographical position.

The statistics module can further be arranged to calculate at least one performance indicator that indicates how well the vehicle crew manoeuvred the ground combat vehicle based on the time delay between the different events. For example the statistics module can based on the time delays of the examples above calculate a score for the vehicle crew and/or the individual crew members based on a predetermined scale. Hereby, the proposed evaluation system can automatically grade the individual or joint ability of a vehicle crew to manoeuvre the ground combat vehicle which can be very helpful in determining whether a vehicle crew is ready for live missions.

Advantageously the processing unit is further arranged to selectively reproduce mission related information with particular relevance for one or more members of the vehicle crew based on a selection of one or more crew members indicated by a user of the system. Hereby, is enabled for a user of the system to efficiently evaluate the ability of a specific crew member to manoeuvre the ground combat vehicle. By for example indicating to the system that evaluation of the vehicle gunner the system can reproduce the sensors information and possibly also the weapon state information and/or the vehicle state information that affects and/or is affected by the vehicle gunners actions during the mission. In order to be able to indicate this and other selections the system comprises user input means, such as a computer mouse, a keyboard, a touch screen, a voice command functionality or the like.

In accordance to what is described above it should be understood that the system according to the present invention advantageously is arranged to reproduce the registered mission related information in a synchronized manor using a playback device integrated in the ground combat vehicle, said playback device typically comprising at least one display and at least one loudspeaker.

Advantageously the system also comprises a data transfer interface that enables transmission of the stored information to an external data carrier so as to enable reproducing the above mentioned information using a playback device external of the ground combat vehicle. This enables reproduction of the information using a playback device in for example an education environment, such as a lecture room.

Modern ground combat vehicles are often equipped with various sensors for audio and image recordings, digital storage mediums for storage of information, and playback devices for reproduction of images and audio, such as display screens and loudspeakers. Navigation modules, weapon state modules and vehicle state modules for registering position of ground combat vehicles, weapon states and other non weapon related states also commonly exist in current ground combat vehicles. Preferably the system according to the present inventions is partly comprised of these already existing components, wherein these are controlled by the processing units so as to enable the immediate evaluation of the manoeuvring of the ground combat vehicle after mission completion, as have been described above. Apart from the above described system and combat vehicles the present invention also provides a method and a computer programme for after a mission being completed by the ground combat vehicle evaluating manoeuvring of the ground combat vehicle during the mission.

The method at least comprises the steps of by means of a sensor device registering mission related information, and storing the information registered by the sensor device in a digital storage medium. The method further comprises the step of reproducing the mission related information in the ground combat vehicle after mission completion.

The computer programme is comprised of a computer readable programme code which when executed by a processing unit of a ground combat vehicle based system comprising at least a sensor device, a digital storage medium and a playback device, causes the system to perform the above described method.

According to a further aspect of the invention it is provided a graphical user interface for after a mission being completed by the ground combat vehicle to evaluate manoeuvring of the ground combat vehicle during the mission. The user interface is configured to be displayed on a display screen of the ground combat vehicle to enable immediate evaluation of the mission in the vehicle.

Further advantageous aspects of the system, the ground combat vehicle, the method, the computer programme and the user interface according to the invention will be apparent from the herein after following detailed description, and from the claims following thereafter.

### SCHEMATIC DESCRIPTION OF THE DRAWINGS

For a more detailed and complete understanding of the present invention and further objects and advantages thereof reference is made to the following detailed description that should be read in conjunction with the accompanying drawings wherein like reference characters refer to like parts throughout the different figures, and in which:

FIG. 1 schematically illustrated a system for evaluation ground combat vehicle manoeuvring, according to an embodiment of the invention;

FIGS. 2-5 are flow diagrams illustrating methods for evaluating ground combat vehicle manoeuvring, according to different embodiments of the invention;

FIGS. 6A-6B shows examples of a main view of a graphical user interface for the system according to the invention;

FIGS. 7A-7B shows a solution for enabling a user via said user interface to manually register events that occurred during for example a training mission, which subsequently can be used for evaluation of combat vehicle manoeuvring;

FIG. 8 shows a menu view of the graphical user interface for the system according to the invention; and

FIG. 9 shows a statistics view of the graphical user interface for the system according to the invention.

### DETAILED DESCRIPTION OF THE INVENTION

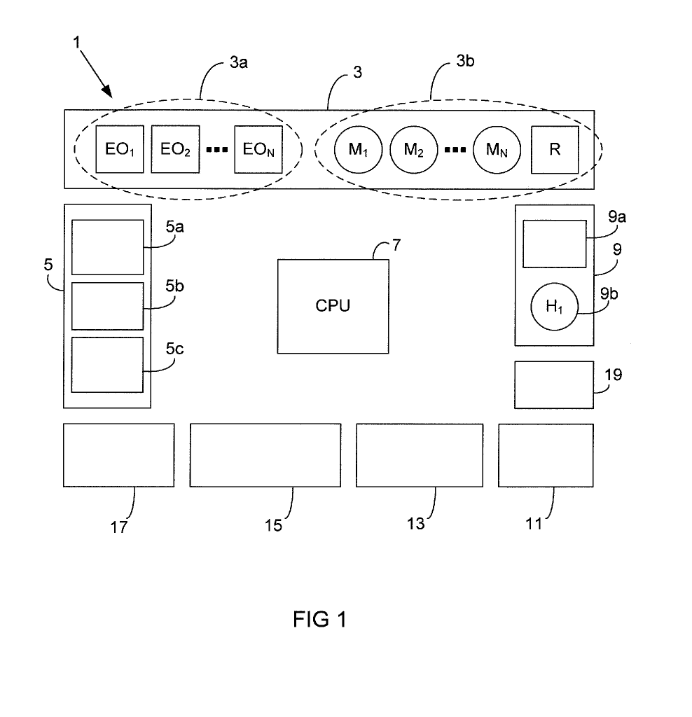

FIG. 1 schematically illustrates a system 1 for evaluation of combat vehicle manoeuvring, according to an embodiment of the invention. By “manoeuvring” is in this context meant to refer to the general operation of a combat vehicle and the subsystems comprised therein and not just the physical movement of the vehicle.

The system 1 is comprised in a ground combat vehicle (not shown), such as a tracked vehicle or an armoured wheeled vehicle, which is manoeuvred by a vehicle crew having at least one crew member. Typically the system 1 is intended for a ground combat vehicle that is manoeuvred by a crew having at least three crew members, comprising a driver, a gunner and a vehicle commander.

The system comprises a sensor device 3 which in turn comprises an image recording device 3a and an audio recording device 3b.

The image recording device 3a comprises a plurality of electro-optical sensors EO₁-EO_{N} for recording of image information in the form of still images and/or video sequences. The electro-optical sensors may be arranged to record images showing what takes place inside and/or outside the vehicle. At least one electro-optical sensor is arranged to register images of at least parts of the field of view seen by a vehicle gunner. For example an electro-optical sensor may be arranged in such way that it registers images corresponding to the view that the gunner sees when the gunner aims with a weapon of the ground combat vehicle. Such electro-optical sensor is suitably a digital video camera configured to register images within the visual and/or infrared (IR) area. This electro-optical sensor will hereinafter be referred to as a sight camera. The image recording device 3a preferably further comprises an electro-optical sensor arranged to record images of at least parts of the field of view that is seen by a vehicle driver. This electro-optical sensor will hereinafter be referred to as a driver camera.

The audio recording device 3b comprises a plurality of microphones M₁-M_{N} for registering conversation between the crew members of the vehicle (intercom-conversations). The audio recording device further comprises a radio unit, R, for registering radio based voice communication between crew members of the vehicle and persons externally of the vehicle, such as a combat leader or an exercise leader. The audio recording device 3b may further comprise microphones for registering other sounds in or outside the vehicle that may be of relevance for the mission and thereby also for manoeuvring of the vehicle.

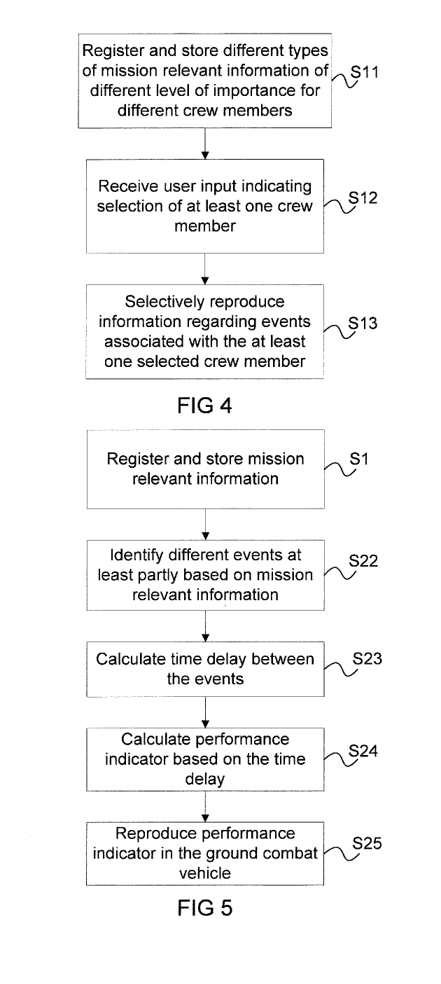

The system 1 further comprises a storage medium 5 for storage of digital information. The storage medium stores the sensor information that is registered by the sensor device 3, i.e. the audio and image information that is registered by the audio recording device 3b and the image recording device 3a respectively, in a first memory module 5a for storage of mission related information. The storage medium 5 further comprises a second memory module 5b in which it stores a computer programme which when executed by a processing unit 7 of the system 1 reproduces the registered and stored sensor information via a playback device 9 comprised in the system 1 in a fashion as described in more detail with reference to FIGS. 6A-9 below. This playback device 9 comprises at least one display 9a for reproduction of the registered image information and at least one loudspeaker 9b for reproduction of the registered audio information. Preferably display and loudspeakers already existing in the ground combat vehicle are used for this purpose.

The system 1 further comprises a navigation module 11, which suitably comprises a GPS-receiver, arranged to register the geographical position of the ground combat vehicle. The geographical position of the vehicle is continuously sampled during the mission and position and time is stored in the module 5a for mission related information of the storage medium 5, for enabling subsequent reproduction together with sensor information that have been registered by the sensor device 3.

The storage unit 5 further comprises a third memory module 5c for storing of terrain information relating to the geographical area where the mission is performed. The terrain information suitably comprises digital maps and/or aerial photographs, such as aerial or satellite images over the mission area. As is apparent from the FIGS. 6A and 6B the processing unit 7 is arranged to use the positional information that have been registered by the navigation module 11 together with said terrain information in order to reproduce the sensor information together with positional information showing the position of the ground combat vehicle and/or its movement at the instance of time when the reproduced sensors information was registered.

The ground combat vehicle typically comprises one or more weapon systems that are operated by one or more vehicle gunners. In the following description it will be assumed that the ground combat vehicle is equipped with a weapon system comprising a laser range finder and at least a main gun equipped with an IR-sight.

The system 1 comprises a weapon state module 13 registering the state of the weapon system of the ground combat vehicle at different instances of time during the mission. The weapon state module 13 registers at least when a weapon is fired and preferably also which ammunition that is used and/or from which of a plurality of ammunition stores ammunition is fed to the weapon. In the case where the ground combat vehicle is equipped with a laser range finder the weapon state module 13 preferably also register the instance of time related to ranging of a target, and the measured range at that instance of time. Apart from this the weapon state module 13 may also be arranged to register positions and/or movements of the weapon systems that indicates how the vehicle gunner aims the weapon system at different targets. For example the weapon state module 13 may be arranged to register by means of different angular transducers how an aim control stick used in aiming of the weapon at a target is moved laterally and vertically.

The weapon state module is primarily intended to be used in evaluation of how a vehicle gunner manoeuvres the ground combat vehicle with respect to operation of its weapon systems. For example it can be used to evaluate how quickly a vehicle gunners succeeds to aim the weapon at a an emerging target and how frequently the vehicle gunner uses the laser range finder, and based on these and/or on other parameters to automatically calculate a performance indicator indicating the ability of the vehicle gunner to operate the weapon system.

The registered weapon state information is stored in the memory module 5a for mission related information of the storage medium 5. Just like for all other mission related information that is registered by the components comprised in the system 1 the weapon state information is stored in a fashion that indicates the instance of time when it was registered in order to be reproduced synchronized with the rest of the registered information at the following moment of reproduction. Hereby, it should understood that the processing unit 7 is arranged to use the above mentioned weapon state information in order to reproduce the sensor information from the image recording device 3a and the audio recording device 3b together with weapon state information by means of the playback device 9 in such a way that the sensor information that was registered at a certain instance of time is reproduced together with weapon state information indicating the weapon state at that instance of time.

The system 1 also comprises a vehicle state module 15 that registers the state of non-weapon related systems of the ground combat vehicle at different instances of time during the mission. The vehicle stat module 15 may be arranged to register information indicating how the vehicle is driven, such as throttle action, brake action, steering action, gear and/or fuel consumption at different instance of time. The vehicle state module 15 can further be arranged to register vibration movements of the vehicle by using one or more accelerometers. The vehicle state information is primarily intended to be in evaluation of how a vehicle driver manoeuvres the ground combat vehicle with respect to movement of the vehicle. For example it can be used to evaluate how quickly a vehicle driver succeeds to move the vehicle between two destinations, how much fuel that is consumed during the movement, and how shaky the movement is experienced by the vehicle crew, and based on these and/or on other parameters to automatically calculated a performance indicator indicating the ability of the vehicle driver to relocate the vehicle.

The vehicle state information is in a similar fashion as described above regarding the weapon state information stored in the memory module 5a for mission related information in order to later be reproduced synchronized with the registered audio and image information, and possible other registered information, such as the positional information and the weapon state information.

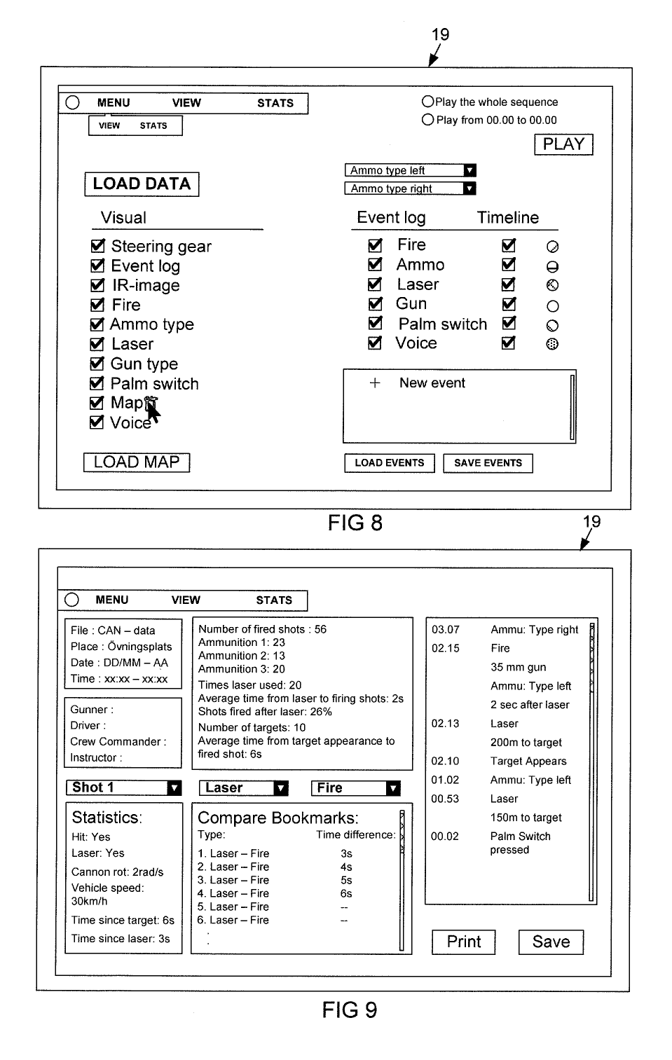

The system 1 is further arranged at least partly based on the registered mission related information to determine the time delay between different events, and based on the determined time delay to determine a performance indicator for one or more of the crew members. This is performed by a statistics module 17 comprised in the system 1. The processing unit 7 is arranged to notify the performance indicator to the crew members after mission completion via the playback device 9, for example by means of showing on the display 9a the performance indicator in the form of a grade according to a predetermined scale. The statistics module 17 is further arranged at least partly based on the registered mission related information to keep statistics of events that occurs during the mission. As shown in FIG. 9 the statistics module 17 may for example be arranged to keep statistics on how much ammunition that have been used, which type of ammunition that have been used, how often the laser range finder have been used, how many shots that have been fired after laser distance ranging, and the average time delay from when the range to a target have been measured until a shot have been fired.

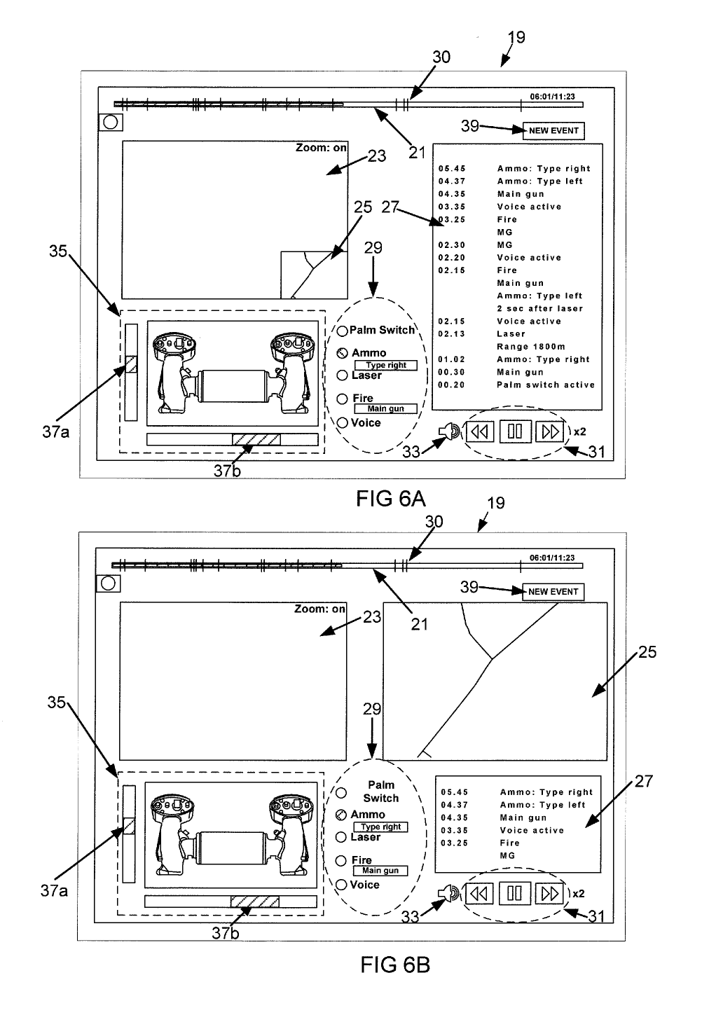

According to a preferred embodiment the statistics module 17 is further configured to determine the time delay from when a vehicle gunner should have spotted a target until a shot have been fired at the target. The instance of time when a shot have been fired may automatically be provided from the weapon state information. In order to determine the instance of time when a target should have been spotted by the vehicle gunner manual input of information to the system may be desirable. According to an embodiment the system 1 is arranged to receive user input data indicating the instance of time when a target should have been spotted by the vehicle gunner. This may for example be performed by means of that an exercise leader inputs the instance of time when the target should have been spotted by the vehicle gunner via user input means comprised in the system 1, such as a computer mouse, a keyboard, a voice command function or the like. An example of such method is described below with reference to the FIGS. 7A and 7B. In a completely automated method the system 1 may comprise means for automatically detecting a target based on the registered sensor information and thereby register the instance of time when the target should have been spotted by the vehicle gunner. According to an embodiment the system 1 may for example comprise means, such as an image recognition module, registering said instance of time based on the image information that is registered by the sight camera. In a different embodiment the system 1 may comprise means that registers said instance of time upon reception of a radio signal that is sent by and exercise leader having knowledge when practise targets become visible for the vehicle driver.

As mentioned before the system 1 is integrated in a ground combat vehicle and arranged to reproduce the registered mission related information in the ground combat vehicle after completion of the mission so as thereby to enable immediate evaluation of the ground combat vehicle manoeuvring during the mission. It can however be advantageous to be able to get the registered mission related information to be reproduced in an education room for example in order to jointly review the sequence of events during a mission comprising a plurality of combat vehicles from the perspective of an individual crew member. Therefore the system 1 is equipped with a data transfer interface 19 that enables transfer of the stored mission related information to an external data carrier in order to enable reproducing the above mentioned information via a playback device external of the vehicle.

The data transfer interface 19 may for example comprise a USB-port (Universal Serial Bus), a FireWire-port, a Bluetooth-transmitter or other type of interface that enables transmission of the stored mission related information to an external data carrier.

Below is described a method for evaluation of ground combat vehicle manoeuvring during a mission. It should be understood that the method, if not otherwise stated, is performed by the above described system 1 when the processing unit 7 executes the computer programme stored in the memory module 5a. In connection with describing the method simultaneous reference to the system in FIG. 1 will be made.

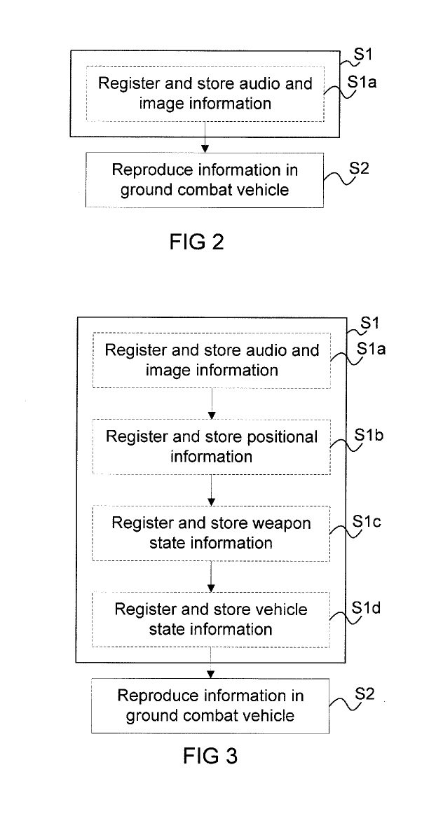

FIG. 2 show a generic method for evaluation of manoeuvring of a ground combat vehicle, according to an embodiment of the invention.

In a first step S1 mission related information is registered and stored, that is information that is of relevance for a mission currently being performed by the ground combat vehicle. As is apparent from the figure the registration of mission related information comprises at least one step 51a wherein image and audio information is registered using the sensor device 3 of the system 1 described above.

In a subsequent and final step S2 the mission related information is reproduced in the ground combat vehicle after mission completion. This is performed as described above using a playback device 9 integrated in the vehicle.

FIG. 3 show method for evaluation of manoeuvring of a ground combat vehicle in more detail, according to an embodiment of the invention.

Herein the step Si for registration of mission related information is seen comprising a plurality of sub steps 51a-51d. In accordance with the above S1a is a step wherein image and audio information is registered using the sensor device 3 and stored in the storage medium 5. Step S1b comprises registration and storage of positional information using the navigation module 11; step S1c comprises registration and storage of weapon state information using the weapon state module 13; and step S1d comprises registration and storage of vehicle state information using the vehicle state module 15.

In the subsequent and final step the mission related information that have been registered and stored in step S1 is reproduced using a playback device 9 integrated in the vehicle. As described above all mission related information is reproduced in a synchronized manor so that information that have been registered simultaneously also is reproduced simultaneously.

FIG. 4 shows a method for evaluation of manoeuvring of a ground combat vehicle, according to a different embodiment of the invention. In this embodiment the evaluation is selective, by which is meant that the evaluation can take place focused on one or more members of the crew of the ground combat vehicle.

In a first step S11 different types of mission related information having different level of importance of different crew members is registered and stored, which means that the different information types affects and/or is affected in different magnitude by the actions of different crew members. With reference to FIG. 2 this may for example mean that both weapon state information that is of highest level of importance for a vehicle gunner of the vehicle crew and vehicle state information that is of highest level of importance for a vehicle driver of the vehicle crew is registered and stored. Thereby, step S11 of FIG. 4 may for example be replaced by the sub steps S1c and S1d of FIG. 2.

In a second step S12 user input indicating a selection of at least one crew member is received. This is suitably performed using the above mentioned user input means.

In a third and final step S13 mission related information regarding events associated to the selected crew member or the selected crew members that was indicated by the selection in step S12 is selectively reproduced. This means that all mission related information of highest level of importance for the selected crew member or the selected crew members is reproduced by means of the playback device 9 while remaining other mission related information that have been registered and stored but is assumed to be of less importance for the selected crew member or the selected crew members is not reproduced.

FIG. 5 shows a method for evaluation of manoeuvring of a ground combat vehicle, according to a different embodiment of the invention. In this embodiment the evaluation comprise automatic grading of the crew members joint or individual ability to manoeuvre the ground combat vehicle.

In a first step S1 mission related information is registered and stored as described above with reference to FIG. 2 or 3.

In second step S22 different events is identified at least partly based on the registered mission related information. Multiple examples of different events that may be identified based on the mission related information have been disclosed above and do therefore not require repeated disclosure here. However, for the continued disclosure of the method it may be mentioned as an example that the event when a shot is fired from a weapon system of the ground combat vehicle, which may be identified based on weapon state information registered by the weapon state module 13, as described above. As also described above, and described in more detail with reference to the FIGS. 7A and 7B below, also user input information may be used by the system 1 for identifying different events, such as information regarding the instance of time when a target should have been identified by a vehicle gunner.

In a third step S23 the time delay between two events identified in step S22 is calculated. With regard to the provided examples this means that the time delay from when the target should have been identified by the vehicle gunner (presumed spotting of the target) until the shot has been fired is calculated. Preferably the method comprises that during a mission when a plurality of targets should be identifiable and fired at to also determine that average time from presumed spotting of a target until a shot is fired at the target.

In a fourth step S24 a performance indicator is calculated based on the time delay that was calculated in step S23. As mentioned above the performance indicator could for example be comprised of a numeric grading according to a predetermined scale. For example this step may comprise the sub steps of storing one or more tables (look up tables) in which different time intervals between different events corresponds to different grades, and to read off said tables so as to determine a performance indicator in the form of a grade for the determined time delay of the average time delay.

In a fifth and final step S25 the performance indicator determined in step S24 is reproduced in the ground combat vehicle after mission completion. This is accomplished using the playback device 9 integrated in the ground combat vehicle, for example by means of displaying the performance indicator in the display 9a.

The FIGS. 6A through 9 shows different views of a graphical user interface 19 for the before mentioned computer programme that is stored in the memory module 5b of the storage medium 5, which computer programme causes the system 1 to perform that above mentioned methods when executed by the processing device 7. The user interface is displayed on the display 9a of the playback device 9 during the herein described evaluation of the ground combat vehicle manoeuvring. Thus, the user interface 19 may be stated to be a component of the system 1 that is used in order to graphically reproduce the registered and stored mission related information after completion of mission.

FIG. 6A shows an exemplary main view of the graphical user interface 19 when the user have selected to selectively display mission related information of highest level of importance for the vehicle gunner in order for evaluating the gunner's ability to manoeuvre the ground combat vehicle with respect to its weapon systems.

The main view comprises a time line 21 showing at which instance of time during the mission the mission related information that is reproduced was registered, or put differently; which instance of time during the mission that currently is reproduced.

The main view further comprises an image window 23 in which image information that was registered during the mission by means of the image recording device 3a is reproduced. In this example the image information comprises a video sequence that was registered by the above mentioned sight camera in the IR area.

Inside in the bottom right corner of the image window 23 there is a position window 25 in which positional information registered during the mission by means of the navigation module 11 is reproduced. The positional information is in this example reproduced in the form of an indicator on top of picture (satellite image) over the mission area, which is stored in memory module 5c of the storage medium 5.

The main view further comprises an event log 27 wherein all events registered based on the registered mission related information and possible user input information is reproduced with time indicators for the respective events. Each type of events is displayed using different colours, which are elucidated by means of an event elucidation field 29 of the main view. Examples of events that in FIG. 6A is displayed in the event log 27 are listed below:

“Palm switch active”: activation of a dead man's switch of an aim control stick used by the vehicle gunner to aim a main gun of the ground combat vehicle,

“Main gun”: activation of the main gun,

“Ammo: Type right”: feeding of ammunition to the main gun from one (the right) of a plurality of ammunition stores,

“Laser-Range 1800 m”: ranging of distance to a target using the laser range finder—distance determined to be 1800,

“Voice active”: voice communication (intercom or radio) registered,

“Fire—Main gun—Ammo: Type left—2 sec after laser”: main gun fired using ammunition from another (the left) of a plurality of ammunitions stores—weapon fired 2 seconds after ranging using the laser range finder.

The main view can be said to present an interactive video that reproduces the sequence of events during the mission by means of reproducing the different types of mission related information registered during the mission (sensor information, positional information, weapons state information and vehicle state information) in a synchronized and chronological fashion. As soon as the interactive video reaches an instance of time when an event occurred the event is presented in the event log 27, which thereby is updated with new events as time of the interactive video passes. As seen the computer programme is also arranged indicate all events registered during the mission by means of outputting event indicators 30 along the time line 21, wherein the placing along the time line corresponds to the instance of time when the respective event occurred. In this example the event indicators 30 are shaped as lines having a colour which is associated with the type of event that each respective event indicator indicates, in accordance with the colour assignment that is described in the event elucidation window 29 which also is used in the event log 27. As is apparent from FIG. 6A also events that not yet have taken place in time for the virtual video is shown along the time line 21.

The main view also comprises a controller 31 that enables the user to pause and fast forward/rewind the virtual video. The user can also skip parts of the virtual video by means of marking an instance of time along the time line 21, whereby the interactive video is played from that instance of time. This means for selection of which part of the virtual video us of interest for viewing, together with the event indicators along the time line 21 provides the user the possibility to fast forward pass uneventful parts of the virtual video (corresponding to uneventful parts of the reproduced mission) and to focus on the parts where interesting events occurred.

The computer programme is arranged to synchronously with the display of the virtual video on the display 9a to reproduce the audio information registered during the mission in the form of a sound track that is played using the playback device 9b. Thereby, the main view of the graphical user interface 19 also comprises an audio controller 33 which may controlled by the user so as to de-activate and activate the audio and/or raise or lower the volume.

The graphical user interface is further seen comprising an aim control stick window 35 in which weapon state information indicating the position of an aim control stick of the ground combat vehicle is reproduced. The aim control stick is used by the vehicle gunner to aim the main gun at a target and the position of the aim control stick, and in particular its position over time, thereby provides relevant information of the ability of the vehicle gunner to handle the main gun. Apart from an image of the aim control stick the aim control stick window 35 comprises a vertical indicator 37a and a lateral indicator 37b indicating how the aim control stick was positioned at the reproduced instance of time. The weapons state information used to indicate the position of the aim control stick is preferably provided from different angular transducers, comprised in the system, and which are arranged to detects the position of the aim control stick and its vertical and lateral change in position.

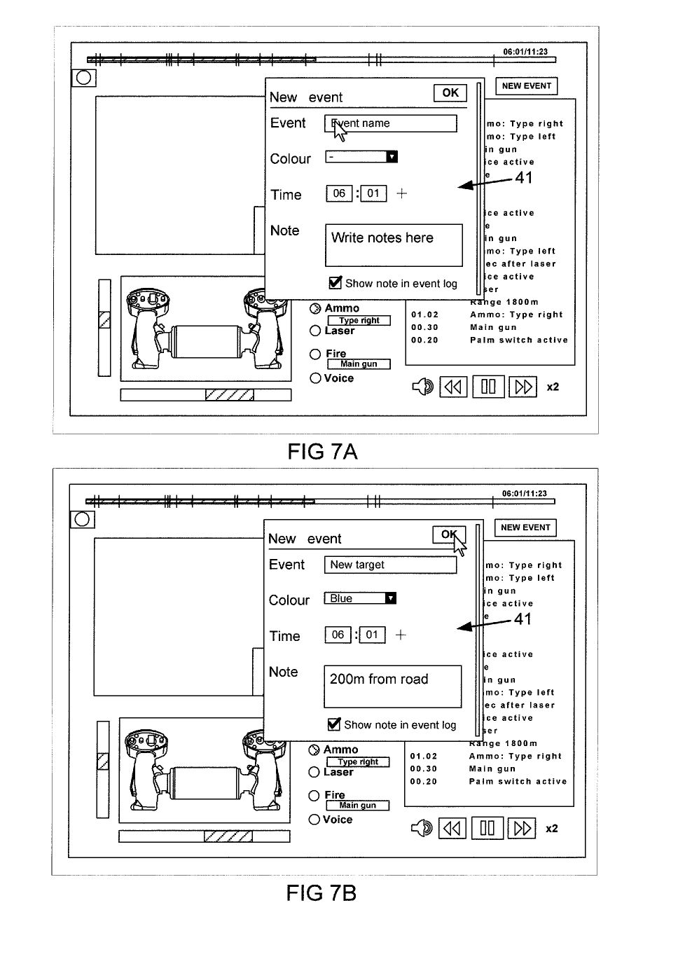

The main view further comprises means 39 for user input of events that has taken place during the mission but that were unable to be automatically be detected by the system 1. In this example the means 39 is comprised of a clickable button. This function will be described in more detail below with reference to the FIGS. 8A and 8B.

FIG. 6B shows another exemplary embodiment of a main view of the user interface 19. The only difference in comparison with the main view of FIG. 6A is that the position window 25 is lager and displayed separately from the image window 23. In order to provide room for the larger position window 25 the event log 27 is smaller and will thereby not hold as many historical events.

FIG. 7A show a window 41 for user input of events occurring during the mission but which were not automatically detectable by the system 1. The event user input window 41 pops up on the graphical user interface 19 when a user, such as an exercise leader, clicks on the means 39 for user input of events in the main view. The window comprises at least two fields, one field for input of the name of the event desired by the user to register (field “Event”) and one field for input of the instance of time during the mission when the event occurred (field “Time”). In the illustrated example the window 41 also comprises a field for selecting a colour for the event (field “Colour”), whereby the event can be displayed with the selected colour in the event log 27 and along the time line 21 (in the form of an event indicator), and a field for input of notes (field “Notes”), which may be displayed together with the event name in the event log 27. The window 41 further comprises means for selection of whether the user input information should be displayed in the event log 27 when the virtual video reproducing the mission is viewed, in this example in the form of a check box (check box “Show note in event log”)

FIG. 7B shows an example of when a user via the window 41 has selected to manually register an event in the form of when a target become visible for the vehicle gunner at the instance of time 6 minutes and 1 second into the mission. Further the user has selected to add a note regarding that the target become visible at 200 meters from a road and that the event should be displayed in the event log 27.

It should be understood that the above described manor for manually registering an event indicating when a target should have been spotted by a vehicle gunner advantageously can be used to enable for the statistics module 17 to calculate the time delay between when a target should have been identified by a vehicle gunner until a shot has been fired, such as described above with reference to FIG. 5. It should also be understood that other types of events also can be registered in this manual fashion in order to be used by the statistics module 17 for calculation of the time delay between different events.

FIG. 8 show a main menu for the user interface 19. Herein, a user such as an exercise leader can select which mission related information registered during the mission that is to be reproduced in the virtual movie. The menu comprises means for selecting what should be displayed in the main view of the interface when the virtual movie is played, in this example in the form of a window (window “Visual”) having a plurality of check boxes wherein the user may check what should be displayed. The menu further comprises means for selecting which events to be shown in the event log 27, along the time line 21, when the virtual video is played, in this example in the form of a window (window “Event log//Timeline”). As can be seen in the lower right portion of the menu the user is also provided with the possibility to manually register events that takes place during the mission via an input field (field “New event”) of the menu.

FIG. 9 shows a statistics view of the user interface 19. In this view various statistics regarding the performed mission is displayed, which statistics have been derived by the statistics module 17 based on the registered mission related information and, in this exemplified case, user input information regarding instances of time during the mission when practise targets became visible for the vehicle gunner. Which statistics information that is displayed is apparent from FIG. 9 and has in part been described above. As for example can be seen the average time delay from when a target become visible for a vehicle gunner until when the vehicle gunner fires a shot is displayed, which for this specific mission turns out to be 6 seconds.

1. Method for evaluation of ground combat vehicle manoeuvring during a mission performed by a ground combat vehicle, comprising the step of:
during the mission, registering mission related information comprising at least image information and audio information registered using a sensor device of the ground combat vehicle,
reproducing the mission related information using a playback device of the ground combat vehicle after completion of the mission.

2. Method according to claim 1, wherein the registered mission related information further comprises at least one of:
positional information indicating the position of the ground combat vehicle at different instances of time during the mission;
weapon state information indicating the state of at least one weapon system of the ground combat vehicle at different instances of time during the mission, and
vehicle state information indicating the state of at least one non weapon related system of the ground combat vehicle, and wherein the reproducing of the mission related information is performed so that mission related information of different types is reproduced synchronously.

3. Method according to claim 1, wherein the registered mission related information further comprises weapon state information indicating the state of at least one weapon system of the ground combat vehicle at different instances of time during the mission, and wherein the reproducing of the mission related information so that image, audio and weapon state information is reproduced synchronously.

4. Method according to claim 1, further comprising the step of after completion of the mission providing, using said playback device, statistics regarding the mission at least partly based on the registered mission related information.

5. Method according to claim 1, further comprising the steps of:
identifying different events, that occurred during the mission, at least partly based on the registered mission related information;
calculating a time delay between a first and second event,
presenting, using said playback device, information based on said time delay.

6. Method according to claim 5, further comprising the steps of:
calculating a performance indicator based on said time delay, and
presenting the performance indicator using said playback device.

7. Method according to claim 5, further comprising the steps of:
receiving manually inputted information regarding said first event, wherein the manually inputted information comprises a time indication for the first event,
identifying the instance of time for said second event based on the registered mission related information, and
calculating said time delay between the first and the second event based on the manually inputted information for the first event and based on the mission related information identifying the instance of time for the second event.

8. Method according to claim 5, wherein the first event is the event of when a target becomes visible for gunner of the vehicle crew and wherein the second event is the event of when a shot is fired by a weapon of the ground combat vehicle handled by the vehicle gunner.

9. Method according to claim 1, further comprising the steps of:
receiving user input information indicating which part of the mission related information that is to be reproduced, and
selectively reproducing the mission related information based on the user input information.

10. Method according to claim 9, wherein the manually inputted information identifies one or more crew members of the ground combat vehicle, further comprising the steps of:
identifying, based on the user input information, mission related information of particular relevance for the one or more identified crew members, and
reproducing solely the identified mission related information of particular relevance.

11. A non-transitory computer readable storage medium having a software program stored therein, the program being for evaluation of ground combat vehicle manoeuvring during a mission performed by the ground combat vehicle, and characterized in that the computer programme program, when executed by a processing unit of a ground combat vehicle based system comprising a member for during the mission registering mission related information comprising at least image information and audio information, a digital storage medium and a playback device, causes the system to perform the method according to claim 1.

12. A system, integrated in a ground combat vehicle, for evaluation of ground combat vehicle manoeuvring during a mission performed by the ground combat vehicle, wherein the system comprises:
a sensor device for registering mission related information comprising at least image information and audio information during the mission,
a digital storage medium for storing the registered mission related information, and
a playback device arranged to reproduce the mission related information in the ground combat vehicle after completion of the mission.

13. The system according to claim 12, further comprising at least one of:
a navigation module arranged during the mission to register mission related information in the form of position information indicating the position of the ground combat vehicle at different instances of time during the mission;
a weapon state module arranged during the mission to register mission related information in the form of weapon state information indicating the state of at least one weapon system of the ground combat vehicle at different instances of time during the mission, and
a vehicle state module arranged during the mission to register mission related information in the form of vehicle state information indicating the state of at least one non weapon related system of the ground combat vehicle, wherein the system is arranged using a playback device to reproduce the mission related information so that mission related information of different types is reproduced synchronously.

14. The system according to claim 12, further comprising a weapon state module arranged during the mission to register mission related information in the form of weapon state information indicating the state of at least one weapon system of the ground combat vehicle at different instances of time during the mission, wherein the system is arranged to reproduce image, audio, and weapon state information synchronously using a playback device.

15. The system according to claim 12, further comprising a statistic module arranged to, at least partly based on the registered mission related information, compile statistical information regarding the specific mission, wherein the playback device is arranged to provide said statistical information after completion of the mission.

16. The system according to claim 12, further comprising a statistics module arranged to, at least partly based on the registered mission related information, identify different events that occurred during the mission, and to calculate a time delay between a first and second event, wherein the playback device is arranged to present information based on said time delay.

17. The system according to claim 16, wherein the statistic module further is arranged to calculate a performance indicator based on said time delay, and wherein the playback device is arranged to present the performance indicator.

18. The system according to claim 16, further comprising a user input member allowing a user to manually input information to the system, wherein the system further is arranged to, receive manually inputted information regarding said first event, wherein said manually inputted information at least comprises a time indication for the first event, identify the instance of time for said second event, and calculate said time delay between the first and second event based on the manually inputted time indication for the first event and the identified instance of time for the second event.

19. The system according to claim 12, wherein the system is arranged to receive manually inputted information indicating which of the registered mission related information that is of interest for reproduction, and selectively reproducing the mission related information using a playback device based on the manually inputted information.

20. The system according to claim 19, wherein the manually inputted information identifies one or more crew members of the ground combat vehicle, wherein the system is arranged to automatically identify, based on the user input information, mission related information of particular relevance for the one or more identified crew members, and to solely reproduce the identified mission related information of particular relevance using the playback device.

21. The system according to claim 12, wherein the system is arranged to reproduce the registered mission related information via a graphical user interface of a display comprised in the playback device.

22. The system according to claim 21, wherein the graphical user interface comprises at least one image window for reproduction of the registered image information and an event log for reproduction of at least registered weapon state information.

23. The system according to claim 22, wherein the graphical user interface further comprises a position window for reproduction of registered positional information.

24. The system according to claim 21, wherein the graphical user interface is arranged to reproduce the relevant mission information in the form of a virtual video displaying relevant mission information of different types synchronously and chronologically.

25. The system according to claim 21, wherein the graphical user interface further comprise means comprises a member for manual input of information regarding at least one event that occurred during the mission.

26. A ground combat vehicle, comprising a system according to claim 12.
